(19) United States
(12) Patent Application Publication
(10) Pub. No.: US 2017/0036203 A1
(43) Pub. Date: Feb. 9, 2017

(54) SLOW DRAW TRANSFER PIPETTES AND RELATED METHODS

(71) Applicant: Nalge Nunc International Corporation, Rochester, NY (US)

(72) Inventors: Christopher Le, Oceanside, CA (US); Ilianna Maria Escalante, San Diego, CA (US)

(21) Appl. No.: 15/231,242

(22) Filed: Aug. 8, 2016

Related U.S. Application Data
(60) Provisional application No. 62/250,578, filed on Nov. 4, 2015.
(60) Provisional application No. 62/202,548, filed on Aug. 7, 2015.

(51) Int. Cl. B01L 3/02; G01N 1/28

(52) U.S. Cl. CPC B01L 3/021; G01N 1/28; B01L 2300/123; B01L 2300/0832; B01L 2400/0481; B01L 2200/0684

(57) ABSTRACT

A transfer pipette includes a draw tube, a first squeeze bulb, and a second squeeze bulb. The draw tube includes a proximal end, a distal end, and a lumen. The first squeeze bulb defines a first fluid chamber in fluid communication with the lumen at the proximal end, and the second squeeze bulb defines a second fluid chamber in fluid communication with the first fluid chamber. When the first squeeze bulb is squeezed into a compressed state, a volume of air is evacuated from the first fluid chamber. When the first squeeze bulb is released from the compressed state, an intended nominal volume of material is drawn into the draw tube through the distal end. When the second squeeze bulb is compressed, at least a portion of the intended nominal volume of material is dispensed from the draw tube through the distal end. Kits including the transfer pipette, and methods for transferring material with a transfer pipette are also disclosed.

### CROSS-REFERENCE TO RELATED APPLICATIONS

This application claims the filing benefits of U.S. Provisional Application Ser. No. 62/202,548 filed Aug. 7, 2015, and U.S. Provisional Application Ser. No. 62/250,578 filed Nov. 4, 2015, each disclosure of each is hereby incorporated by reference herein in its entirety.

### TECHNICAL FIELD

The present invention relates generally to material transfer devices and, more particularly, to pipettes.

### BACKGROUND

Pipettes and capillary tubes are commonly used to collect and dispense liquids. For example, such devices are particularly useful for collecting blood samples. Known pipettes generally include a draw tube and a squeeze bulb connected to the draw tube. The squeeze bulb is compressed and then released in order to draw a liquid into the draw tube through an opening. The liquid is held within the draw tube as a result of the interior of the pipette exhibiting a lower air pressure than an external atmospheric pressure. The squeeze bulb is then compressed to dispense the liquid from the pipette through the draw tube opening.

Known pipettes exhibit the shortcoming that, upon release of the squeeze bulb after its initial compression, liquid is drawn into the pipette through the draw tube opening at a high flow rate. This often results in the simultaneous drawing of air through the draw tube opening, and thus the formation of air bubbles within the volume of liquid held within the pipette. Such air bubbles undesirably inhibit the ability of the pipette to draw and dispense precise volumes of liquid.

Accordingly, there is a need for improvements to known pipettes to address at least this shortcoming.

### SUMMARY

A transfer pipette according to an exemplary embodiment of the invention includes a draw tube, a first squeeze bulb, and a second squeeze bulb. The draw tube includes a proximal end, a distal end, and a lumen. The first squeeze bulb defines a first fluid chamber in fluid communication with the lumen at the proximal end, and the second squeeze bulb defines a second fluid chamber in fluid communication with the first fluid chamber. When the first squeeze bulb is squeezed into a compressed state, a volume of air is evacuated from the first fluid chamber. When the first squeeze bulb is released from the compressed state, an intended nominal volume of material is drawn into the draw tube through the distal end. When the second squeeze bulb is compressed, at least a portion of the intended nominal volume of material is dispensed from the draw tube through the distal end.

A kit according to an exemplary embodiment of the invention includes the transfer pipette described above and a fluid absorbent medium adapted to receive thereon at least a portion of the intended nominal volume of material dispensed from the draw tube.

A transfer pipette according to another exemplary embodiment of the invention includes a body having an open end and a closed end, and first and second fluid passageways located between the open and closed ends, the first fluid passageway terminating at the open end. A first squeeze bulb is located between the first and second fluid passageways and defines a first fluid chamber in fluid communication with the fluid passageways. A second squeeze bulb is located between the second fluid passageway and the closed end and defines a second fluid chamber in fluid communication with the first and second fluid passageways. When the first squeeze bulb is squeezed into a compressed state, a volume of air is evacuated from the first fluid chamber. When the first squeeze bulb is released from the compressed state, a predetermined volume of material is drawn into the first fluid passageway through the open end of the body. When the second squeeze bulb is compressed, the predetermined volume of material is dispensed from the first fluid passageway through the open end.

A method of transferring material with a transfer pipette according to an exemplary embodiment of the invention includes compressing a first squeeze bulb of the transfer pipette, and positioning an open end of the transfer pipette in fluid communication with a supply of material. The first squeeze bulb is released from its compressed state to allow an intended nominal volume of the material to be drawn into the transfer pipette through the open end. The method further includes compressing a second squeeze bulb of the transfer pipette to dispense at least a portion of the intended nominal volume of the material from the transfer pipette through the open end.

Various additional features and advantages of the invention will become more apparent to those of ordinary skill in the art upon review of the following detailed description of exemplary embodiments taken in conjunction with the accompanying drawings. The drawings, which are incorporated in and constitute a part of this specification, illustrate one or more exemplary embodiments of the invention and, together with the general description given above and the detailed description given below, serve to explain the exemplary embodiments.

### BRIEF DESCRIPTION OF THE DRAWINGS

Like reference numerals are used to indicate like features throughout the various figures, wherein:

FIG. 1 is a front perspective view of a transfer pipette according to an exemplary embodiment of the invention.

FIG. 1A is a front perspective view of a transfer pipette according to another exemplary embodiment of the invention.

FIG. 2 is a front elevation view of the transfer pipette of FIG. 1.

FIG. 2A is a top cross-sectional view taken along line 2A-2A of the transfer pipette of FIG. 2.

FIG. 2B is a top cross-sectional view taken along line 2B-2B of the transfer pipette of FIG. 2.

FIG. 2C is a side cross-sectional view taken along line 2C-2C of the transfer pipette of FIG. 2.

FIG. 3A is a schematic side cross-sectional view similar to FIG. 2C, showing first and second squeeze bulbs in a relaxed state.

FIG. 3B is a schematic view similar to FIG. 3A, showing the first squeeze bulb in a fully compressed state.

FIG. 3C is a schematic view similar to FIG. 3B, showing the first squeeze bulb after having released to the relaxed state and drawn in a volume of material.

FIG. 3D is a schematic view similar to FIG. 3C, showing the material held within the transfer pipette.

FIG. 3E is a schematic view similar to FIG. 3D, showing compression of the second squeeze bulb to dispense the material from the transfer pipette onto an absorbent medium positioned within a sample holding container.

FIG. 4 is a perspective view of an exemplary device having a piercing element for piercing the skin of a patient for exposing blood of the patient to be transferred.

FIG. 5 is a perspective view of front and rear mold halves used for blow molding an extruded parison into the shape of the transfer pipette of FIG. 1.

FIG. 6 is a front perspective view of a transfer pipette according to another exemplary embodiment of the invention in which the first squeeze bulb is formed with a shortened length.

FIG. 6A is a front elevation view showing a comparison of the transfer pipette of FIG. 6 with the transfer pipette of FIG. 1.

FIG. 7 is a front perspective view of a transfer pipette according to another exemplary embodiment of the invention in which the first squeeze bulb is formed with a circular cross-section.

FIG. 8 is a front elevation view of the transfer pipette of FIG. 7.

FIG. 8A is a top cross-sectional view taken along line 8A-8A of the transfer pipette of FIG. 8.

FIG. 8B is a top cross-sectional view taken along line 8B-8B of the transfer pipette of FIG. 8.

FIG. 9 is a table displaying dimensions and characteristics of transfer pipettes according to various exemplary embodiments of the invention.

### DETAILED DESCRIPTION

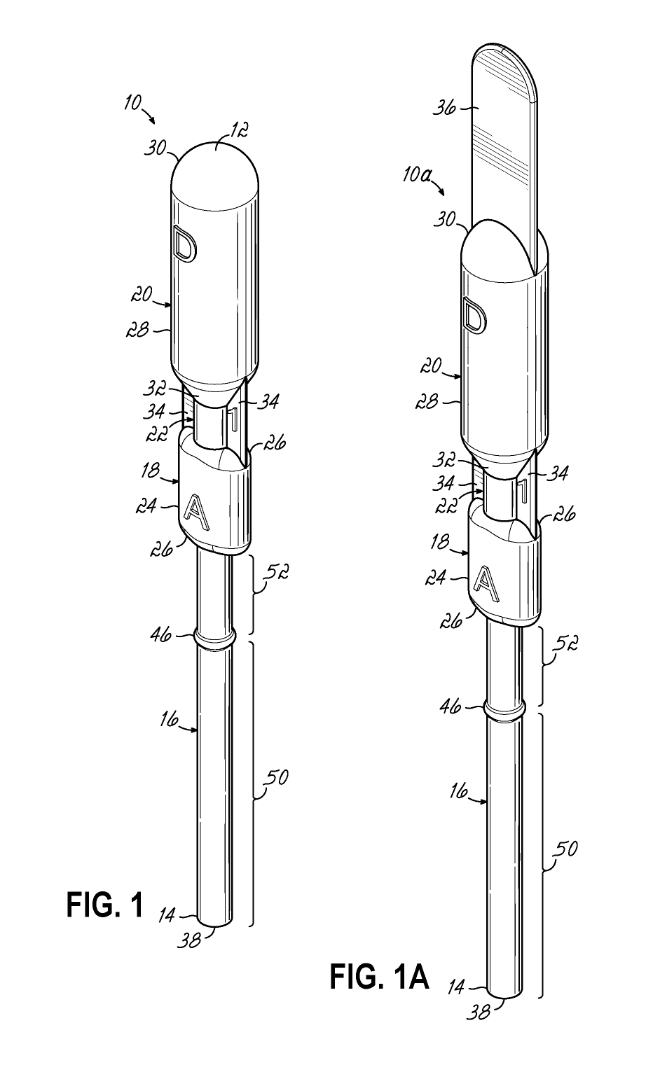

Referring to FIG. 1, a transfer pipette 10 is shown in accordance with a first exemplary embodiment of the present invention. In one embodiment, the transfer pipette 10 is an integrally formed, unitary structure having a proximal end 12 and a distal end 14. The transfer pipette 10 includes a draw tube 16, a first squeeze bulb 18 fluidly and mechanically coupled to the draw tube 16, and a second squeeze bulb 20 fluidly and mechanically coupled to the first squeeze bulb 18 with a connecting tube 22.

As described in greater detail below, in use, to draw a sample of material into the transfer pipette 10, the first squeeze bulb 18 is fully compressed and then released to slowly draw an intended nominal volume of material, such as a liquid or a powder, into the draw tube 16. Advantageously, the slow rate at which the material is drawn, or aspirated, into the draw tube 16 substantially prevents formation of air bubbles within the drawn material held in the draw tube 16, thereby enabling drawing and dispensing of precise volumes of material. The slow material draw rate, and resultant prevention of bubble formation, is enabled by the simultaneous drawing of air from the second squeeze bulb 20 into the first squeeze bulb 18 while drawing the material into the draw tube 16. The second squeeze bulb 20 then may be at least partially compressed to dispense at least a portion of the intended nominal volume of material from the draw tube 16. Accordingly, the first squeeze bulb 18 is configured to function as an aspiration bulb, and the second squeeze bulb 20 is configured to function as a dispense bulb. The embodiments of the present invention disclosed herein are particularly useful for drawing and dispensing very small volumes of material, for example on the order of microliters (μL) as described below.

As shown in the figures, the first squeeze bulb 18 includes tubular portion 24 having proximal and distal rounded portions 26. Similarly, the second squeeze bulb 20 includes a tubular portion 28, a proximal domed portion 30, and a distal conical portion 32. As used herein, the term “tubular” is not limited to structures having circular cross-sectional shapes. In that regard, as shown and as described in greater detail below, the tubular portion 24 of the first squeeze bulb 18 may be formed with a non-circular or circular shaped cross-section, for example. While the draw tube 16, the first squeeze bulb 18, the connecting tube 22, and the second squeeze bulb 20 are shown arranged in a substantially linear configuration to define a common longitudinal axis, it will be appreciated that various alternative configurations of these components may also be provided while achieving the preferred slow draw of material into the draw tube 16 as described in greater detail below.

A pair of tab-like flanges 34 may extend between the proximal rounded portion 26 of the first squeeze bulb 18 and the distal conical portion 32 of the second squeeze bulb 20. In particular, the flanges 34 may be diametrically opposed and extend along the length of the connecting tube 22 so as to define a plane that intersects a longitudinal axis of the connecting tube 22. Advantageously, the flanges 34 increase the rigidity of the transfer pipette 10 and may be gripped by a user for secure handling of the transfer pipette 10. Additionally, the surfaces of the flanges 34 may be provided with visual indicia for identifying the internal contents and/or an internal volume of the transfer pipette 10, for example. The flanges 34 and the connecting tube 22 may be formed with any suitable length to aid in handling and use of the transfer pipette 10.

Referring to FIG. 1A, a transfer pipette 10a is shown in accordance with a second exemplary embodiment of the present invention, for which like reference numerals refer to like features. The transfer pipette 10a is similar in construction to transfer pipette 10, although the transfer pipette 10a includes a tab-like fin 36 extending proximally from the proximal domed portion 30 of the second squeeze bulb 20. Similar to the flanges 34, the fin 36 may be gripped by a user for secure handling of the transfer pipette 10a. Additionally, the surfaces of the fin 36 may be provided with visual indicia for identifying the internal contents and/or an internal volume of the transfer pipette 10, for example. While the fin 36 is shown herein only in connection with transfer pipette 10a, it will be appreciated that the fin 36, or a similar element, may be provided on any one of the other exemplary transfer pipettes disclosed herein, including pipettes 110 and 210 described below.

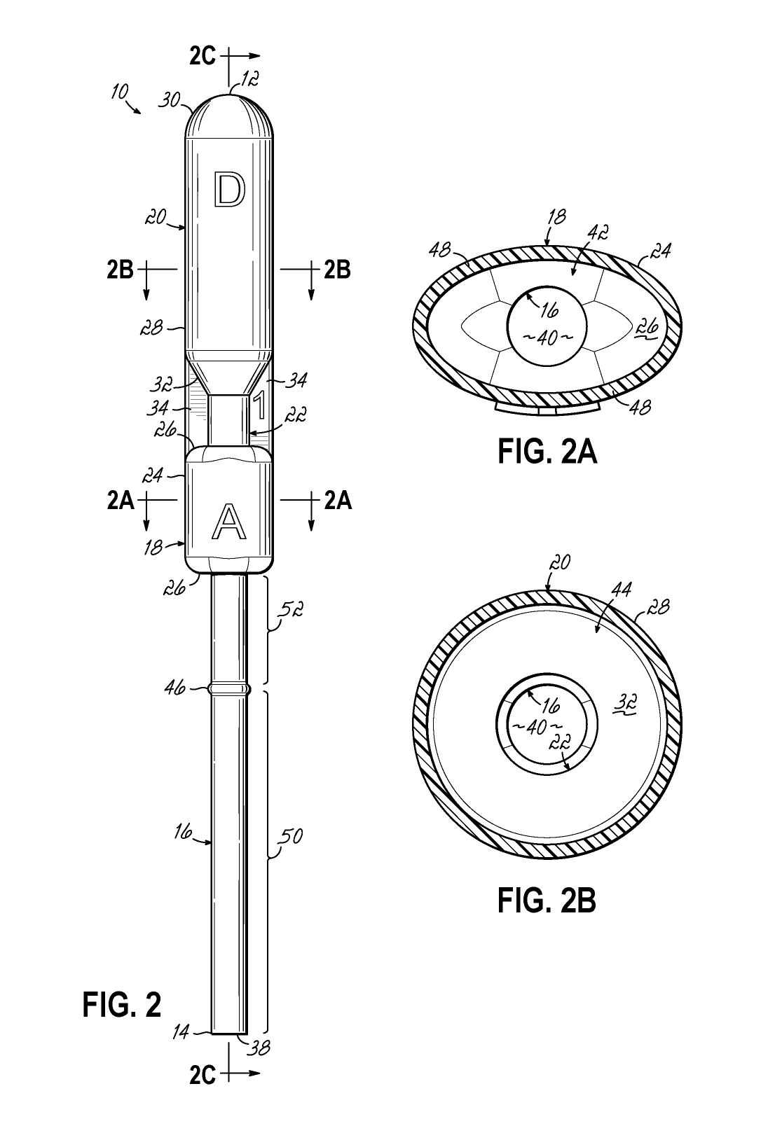

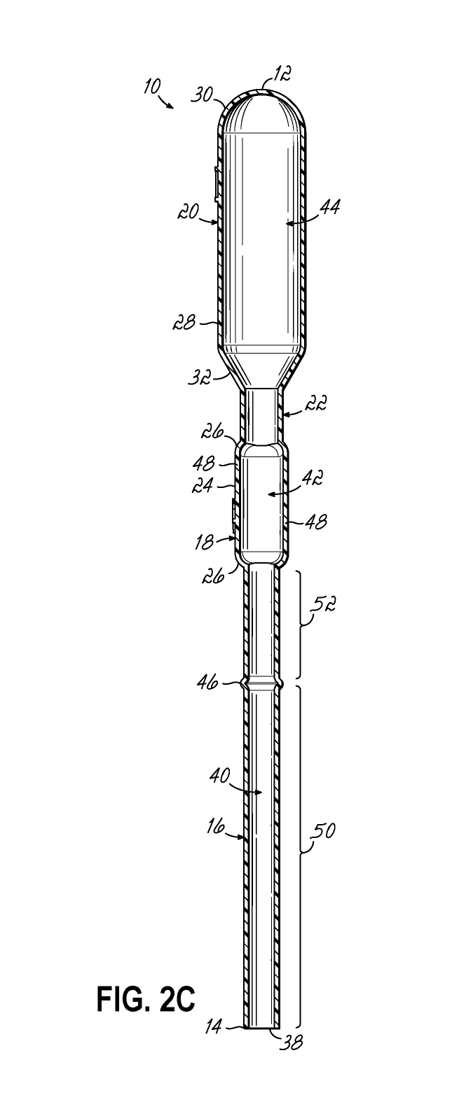

Referring to FIGS. 2-2C, the draw tube 16 includes a distal opening 38 and a lumen 40 extending through the draw tube 16 proximally from the distal opening 38 toward the first squeeze bulb 18. The lumen 40 serves as a first fluid passageway. The first squeeze bulb 18 defines a first fluid chamber 42, and the second squeeze bulb 20 defines a second fluid chamber 44. The first fluid chamber 42 fluidly communicates with the draw tube lumen 40 at a distal end, and fluidly communicates with the second fluid chamber 44 at a proximal end via the connecting tube 22. In this regard, the connecting tube 22 serves as a second fluid passageway. Moreover, each of the first and second fluid chambers 42, 44 is in fluid communication with each of the draw tube lumen 40 and the connecting tube 22.

An outer surface of the draw tube 16 may include one or more volume indicating elements, such as graduation marks, between the proximal and distal ends of the draw tube 16, for providing a visual indication of a volume of material contained within the draw tube 16. In the illustrated embodiments, a volume indicating element is shown in the form of an annular rib 46. It will be appreciated that various other forms of volume indicating elements may be provided, such as printed indicia including rings, notches, numbers, letters, symbols, or other markings, for example. Moreover, it will be appreciated that volume indicating elements may be omitted from the draw tube 16 if desired.

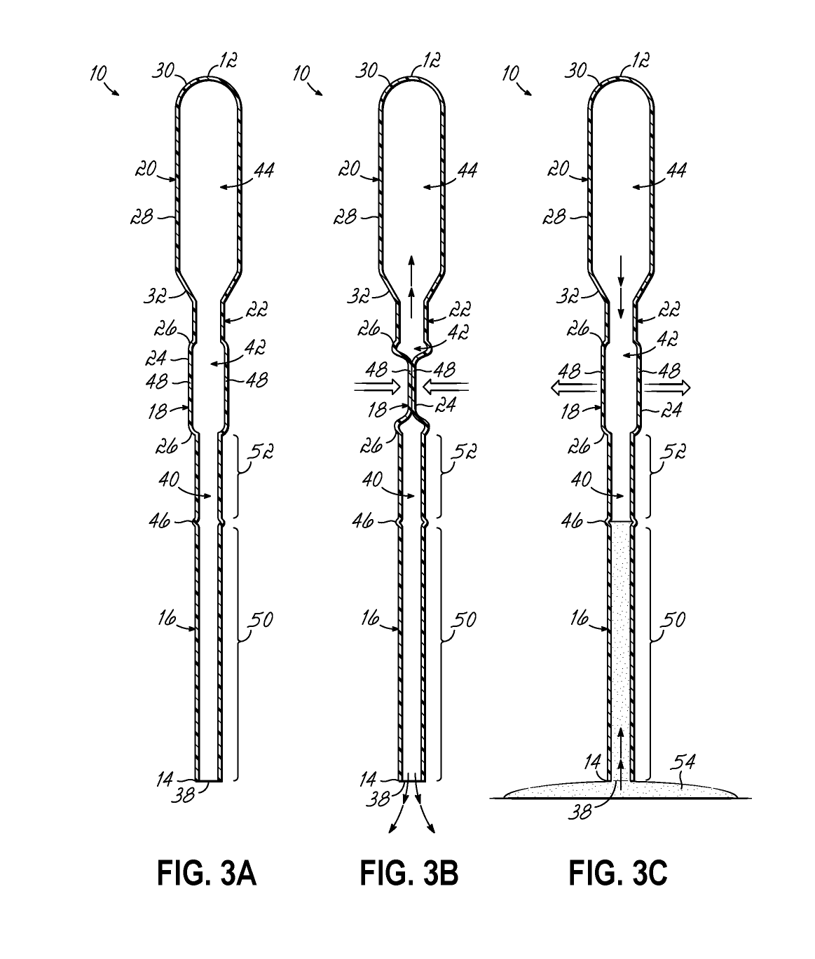

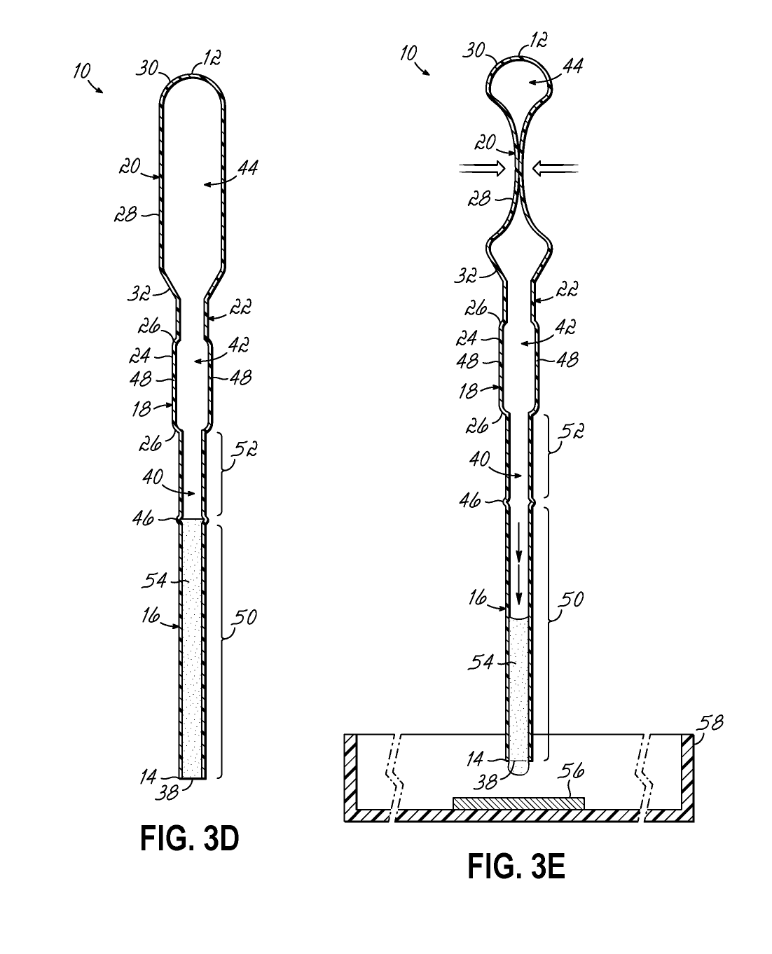

A proximal-most one of the volume indicating elements, such as rib or other graduation mark 46, is positioned at a distance from the distal opening 38 of the draw tube 16 that corresponds to a nominal intended volume (also referred to as a draw volume or aspiration volume) of material that is to be drawn into and held within the draw tube lumen 40 when the first squeeze bulb 18 is fully compressed and then released. The first squeeze bulb 18 is “fully compressed” when its oppositely disposed sidewalls 48 substantially contact one another at their inner faces, as shown in FIG. 3B. Thus, the proximal-most volume indicating element or graduation mark 46 defines a preferred material holding portion 50 of the draw tube 16, and in particular of the draw tube lumen 40, located distally of the proximal-most volume indicating element 46.

The material holding portion 50 may have an internal volume that is equal to the intended nominal volume of material to be drawn into the transfer pipette 10. The proximal-most volume indicating element or graduation mark 46 may further define a buffer portion 52 of the draw tube 16 located proximally of the proximal-most volume indicating element 46 and having an internal volume intended for holding air rather than drawn material. It will be appreciated that compression of the first squeeze bulb 18 to an extent below which its sidewalls 48 substantially contact one another may result in the drawing of a volume of material less than the intended nominal volume of the material holding portion 50. Additional volume indicating elements (not shown) may be positioned distally of the proximal-most indicating element 46 for indicating predetermined portions of the material holding portion 50 that are less than the intended nominal volume of material to be drawn into the draw tube 16.

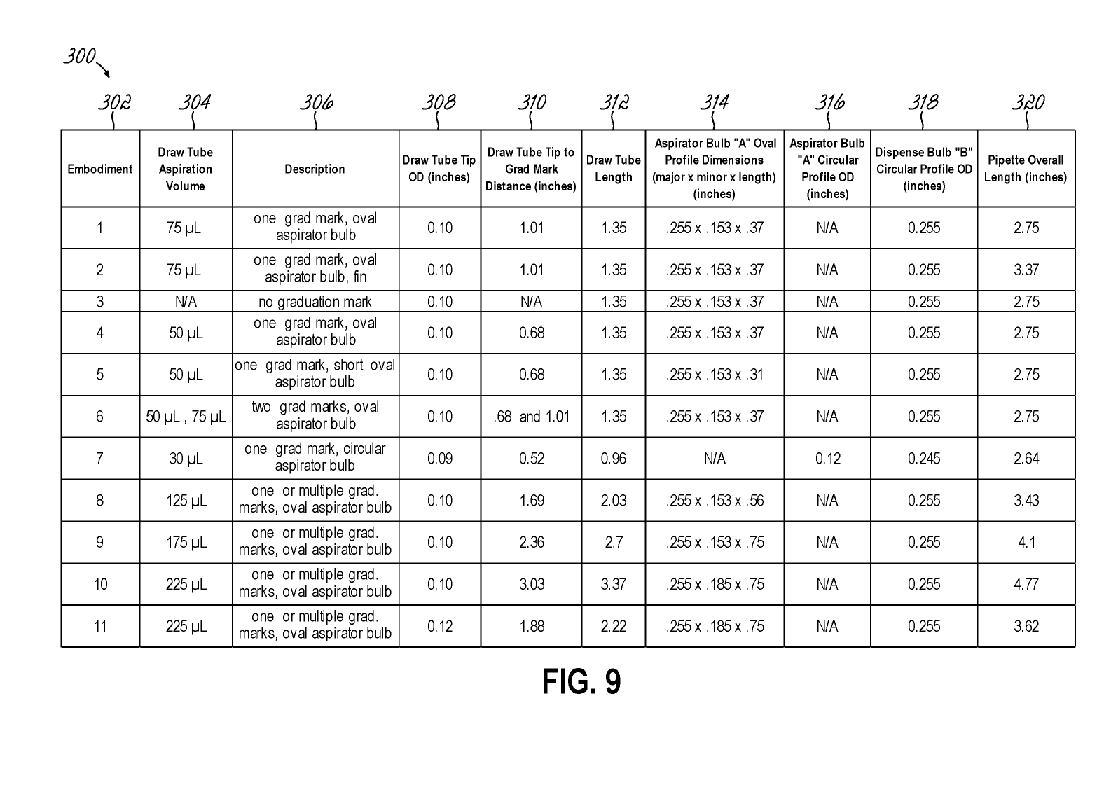

In one embodiment, the transfer pipette 10 may be sized, and the proximal-most volume indicating element 46 may be positioned, such that the material holding portion 50 of the draw tube 16 holds a predetermined volume of material of approximately 20 μL to approximately 250 μL. For example, the material holding portion 50 may have an internal volume of approximately 50 μL, 75 μL, 125 μL, or 175 μL, as indicated in the data table shown in FIG. 9, described below. In another embodiment, the material holding portion 50 may have an internal volume of up to approximately 1,000 μL (1 mL). The draw tube 16 may be formed with an outside diameter that ranges from approximately 0.0625 inches to approximately 0.25 inches, and a wall thickness that ranges from approximately 0.010 inches to approximately 0.030 inches, for example. Furthermore, the transfer pipette 10 may be sized, and the proximal-most volume indicating element 46 may be positioned, such that the buffer portion 52 of the draw tube 16 has an internal volume of at least 25 μL.

The length of the draw tube 16 may be increased or decreased as desired while maintaining an internal volume of the lumen 40, and thus of the material holding and buffer portions 50, 52, by simultaneously adjusting an inner diameter of the draw tube 16 that defines the lumen 40. For example, the draw tube 16 may be lengthened while simultaneously decreasing the inner diameter, or the draw tube 16 may be shortened while simultaneously increasing the inner diameter. For applications in which the material being drawn is blood or other fluids more viscous than water, the draw tube 16 may be formed with an inner diameter of approximately 0.016 inches to approximately 0.024 inches. Additionally, for such blood applications it may be preferable to form the draw tube 16 with an inner diameter of greater than approximately 0.013 inches to greater than approximately 0.100 inches in order to avoid lysis of red blood cells.

The first squeeze bulb 18 may be generally sized such that a volume of the first fluid chamber 42 is greater than the internal volume of the material holding portion 50 of the draw tube 16. That is, the volume of the first fluid chamber 42 may be greater than the intended volume of material to be drawn in, or aspirated, by the draw tube 16. In various embodiments, the volume of the first fluid chamber 42 may be at least 10% greater than, or up to at least 50% greater than, the internal volume of the material holding portion 50, for example. In certain select cases where a capillary action of the draw tube 16, determined by the inner diameter of the draw tube 16, and a surface tension of the material being drawn interact positively to a sufficient degree, the volume of the first fluid chamber 42 may be equal to or less than the internal volume of the material holding portion 50.

The second squeeze bulb 20 may be generally sized such that a volume of the second fluid chamber 44 is greater than the volume of the first fluid chamber 42, and greater than the internal volume of the material holding portion 50 of the draw tube 16. In one embodiment, the second fluid chamber 44 may be formed with a volume that is at least 1.5 times the internal volume of the material holding portion 50, to provide for easy dispensing of the material held within the draw tube 16 when the second squeeze bulb 20 is compressed, as described in greater detail below.

As shown in FIG. 2A, the tubular portion 28 of the first squeeze bulb 18 may be formed with a non-circular shaped cross-section, such as a flattened, oval or elliptical cross-sectional shape, for example. In this regard, the cross-sectional shape may include a major diameter in a first direction, and a minor diameter in a perpendicular second direction. It will be appreciated that various non-circular shapes other than flattened, oval or elliptical cross-sectional shapes may also be used. The first squeeze bulb 18 includes opposed sidewalls 48 that substantially engage one another at their inner surfaces when the first squeeze bulb 18 is fully compressed along its minor diameter. In one embodiment, the first squeeze bulb 18 may be shaped such that the opposed sidewalls 48 are substantially flat or include flat portions.

As shown in FIG. 2B, the tubular portion 28 of the second squeeze bulb 20 may be formed with a substantially circular shaped cross-section, although various other shapes may also be employed.

The transfer pipette 10 may be integrally formed of any flexible polymeric material suitable for use with powder or liquid materials such as blood or other liquids having more corrosive components. For example, the transfer pipette 10 may be formed of a flexible polymer, such as low density polyethylene (LDPE), linear low density polyethylene (LLDPE), medium density polyethylene (MDPE), high density polyethylene (HDPE), polypropylene (PP), polyvinylidene difluoride (PVDF), fluorinated ethylene propylene (FEP), perfluoralkoxy (PFA), or other suitable polymers with known flexibility in thin wall sections. As described below in connection with FIG. 5, the transfer pipette 10 may be extrusion blow molded from resin pellets of any of the above-listed materials, for example.

Referring to FIGS. 3A-3E, an exemplary method of use of the transfer pipette 10 is shown with a series of schematic cross-sectional views. FIG. 3A shows the transfer pipette 10 prior to drawing any material, in which an air pressure within the transfer pipette 10 is equalized with an external ambient air pressure. FIG. 3B shows full compression of the first squeeze bulb 18 in which its opposed side walls substantially contact one another, resulting in the evacuation of air from the first fluid chamber 42 into the second fluid chamber 44 and out through the distal opening 38 of the draw tube 16. Subsequent to the compression step shown in FIG. 3B, the distal opening 38 may be positioned within or in fluid communication with a pool of material 54 as shown in FIG. 3C. The material 54 may be any liquid or powder substance, such as blood for example. The transfer pipette 10 has been successfully tested with various blood substitutes, including a glycerin-water solution maintained at 20 degrees Celsius and having a volume composition of approximately 21% glycerin and a viscosity of approximately 1.8 centipoises, which is representative of the viscosity of blood.

As shown in FIG. 3C, the first squeeze bulb 18 is then released from its fully compressed state, thereby allowing the sidewalls 48 of the first squeeze bulb 18 to expand radially outward so that the first squeeze bulb 18 returns to its original relaxed shape, resulting in the generation of an air pressure within the transfer pipette 10 that is lower than the external ambient air pressure. Consequently, air is drawn from the second fluid chamber 44 into the first fluid chamber 42 while material 54 is drawn into the material holding portion 50 of the draw tube 16 through the distal opening 38. The simultaneous drawing of air from the second fluid chamber 44 enables the material 54 to be drawn into the draw tube 16 at a flow rate sufficiently slow to substantially prevent drawing of air through the distal opening 38 along with the material 54. Advantageously, the slow material draw rate thus substantially prevents the formation of air bubbles or air pockets within the material 54 as it is drawn into the material holding portion 50, thereby ensuring the drawing of an accurate volume of material 54 that corresponds at least to the intended nominal volume indicated by the graduation mark 46. A non-circular shaped cross-section of the first squeeze bulb 18 aids in reducing the rate at which the sidewalls 48 of the first squeeze bulb 18 return to their relaxed state from a compressed state, thereby contributing to a slow material draw rate.

For many applications, in order to generally maintain the bubble prevention benefit described above, a suitable available volume of the material 54 from which the intended nominal volume of material 54 is to be drawn into the material holding portion 50 is approximately equal to the intended nominal volume to be drawn and at least an additional 30% of material 54. For example, a suitable available volume of the material 54 for use with a pipette having an intended draw volume of 75 μL may be at least 100 μL.

The slow draw capability of the transfer pipettes 10 and 10a is enhanced by the presence of second squeeze bulb 20 in fluid communication with first squeeze bulb 18. In particular, as shown in FIG. 3B, when the first squeeze bulb 18 is compressed by the user, air may be expelled from squeeze bulb 18 in two directions, i.e., in a first direction toward the second squeeze bulb 20 and in an opposite second direction toward the draw tube 16 and through the distal opening 38 to ambient. It will be appreciated that the air flows as generally described herein in connection with compression and release of the first and second squeeze bulbs 18, 20 are merely exemplary and are not intended to fully describe nor limit the manner in which the transfer pipettes 10, 10a may operate in various applications.

As a result, the air directed to the second squeeze bulb 20 causes an increase in internal pressure in the second squeeze bulb 20. When the first squeeze bulb 18 is released to draw the material 54 into the draw tube 16, a portion of the air expelled from first squeeze bulb 18 and directed to second squeeze bulb 20 is returned to first squeeze bulb 18 (as indicated by the arrow shown in second squeeze bulb 20) while the material 54 is drawn into the draw tube 16. This reduces the overall pressure differential between the first squeeze bulb 18 and ambient so that the material 54 is drawn into the draw tube 16 at a slow speed of draw that reduces, or possibly eliminates, the presence of bubbles in the drawn material 54. Once the draw is complete, the pressure is equalized at a value less than atmospheric and the material 54 is retained in the draw tube 16.

FIG. 3D shows the transfer pipette 10 after the first squeeze bulb 18 has fully returned to its relaxed state, in which the material holding portion 50 successfully holds the material 54 therein due to the reduced air pressure maintained within the transfer pipette 10.

As shown in FIG. 3E, the second squeeze bulb 20 is at least partially compressed to evacuate air from the second fluid chamber 44, through the first fluid chamber 42, and into the lumen 40 of the draw tube 16, thereby dispensing the material 54 held in the material holding portion 50. In embodiments in which the second fluid chamber 44 is formed with a volume greater than the volume of the first fluid chamber 42, a partial compression of the second squeeze bulb 20 may be sufficient to dispense the full amount of material 54 from the draw tube 16. Furthermore, the second squeeze bulb 20 may be partially compressed to any extent desired, and at any rate desired, so as to slowly dispense a corresponding portion of the material 54 held within the material holding portion 50. As described above, the outer surface of the draw tube 16 may include various volume indicating elements distally of the proximal-most indicating element 46, for providing a visual indication of a volume of material 54 remaining within the material holding portion 50. Accordingly, the second squeeze bulb 20 may be selectively compressed to dispense precise volumes of material 54 from the draw tube 16.

As shown in FIG. 3E, the transfer pipette 10 may be used to dispense material onto an absorbent medium 56, such as a piece of filter paper, contained within a sample holding container 58, such as a Petri-dish as shown. The medium 56 may function to absorb the material 54 for later analysis. After depositing the material 54 onto the medium 56, the medium 56, now containing one or more drops of the material 54 absorbed thereby, may be transferred to another suitable closeable container, preferably having a desiccant therein to dry the material 54 onto and/or into the medium 56 and a closure for closing an opening of the transport container, for transport to a remote analysis site. The closed transport container, including the medium 56 containing the sample of material 54 and the desiccant, may be placed in a sealed sample bag (not shown) which also may include information about the patient and/or the material sample contained herein. It will be appreciated that in certain embodiments, the sample holding container 58 may also include a desiccant and a closure (not shown) so that the sample holding container 58 may also serve as the closeable transport container.

An exemplary application of the setup shown in FIG. 3E may be the screening of blood samples. It is well known that the use of blood samples stored on filter paper has advantages for the detection of blood diseases, such as perinatal HIV-1. For example, once droplets of blood 54 applied to the filter paper 56 have dried, the blood 54 is no longer infectious and can be stored at room temperature, eliminating the need to store and transport blood samples at a controlled low temperature, such as 4° C., or a frozen state. The drying process of the blood 54 may be assisted by the use of the desiccant in the transport container (not shown). Subsequently, the dried blood 54 on the filter paper 56 may be extracted for analysis and detection of disease.

In an alternative exemplary blood screening application, the absorbent medium 56 may be in the form of a paper blood test card (not shown), such as those commonly known in the art, rather than a piece of filter paper. The card may be handled without use of a container 58. A face of the card may include indicia defining a plurality of segregated test regions for receiving a respective plurality of blood droplets. In one embodiment, each of the test regions may be pre-impregnated with a respective reactant configured to react with the respective blood droplet to indicate presence or absence of a particular characteristic of the blood droplet.

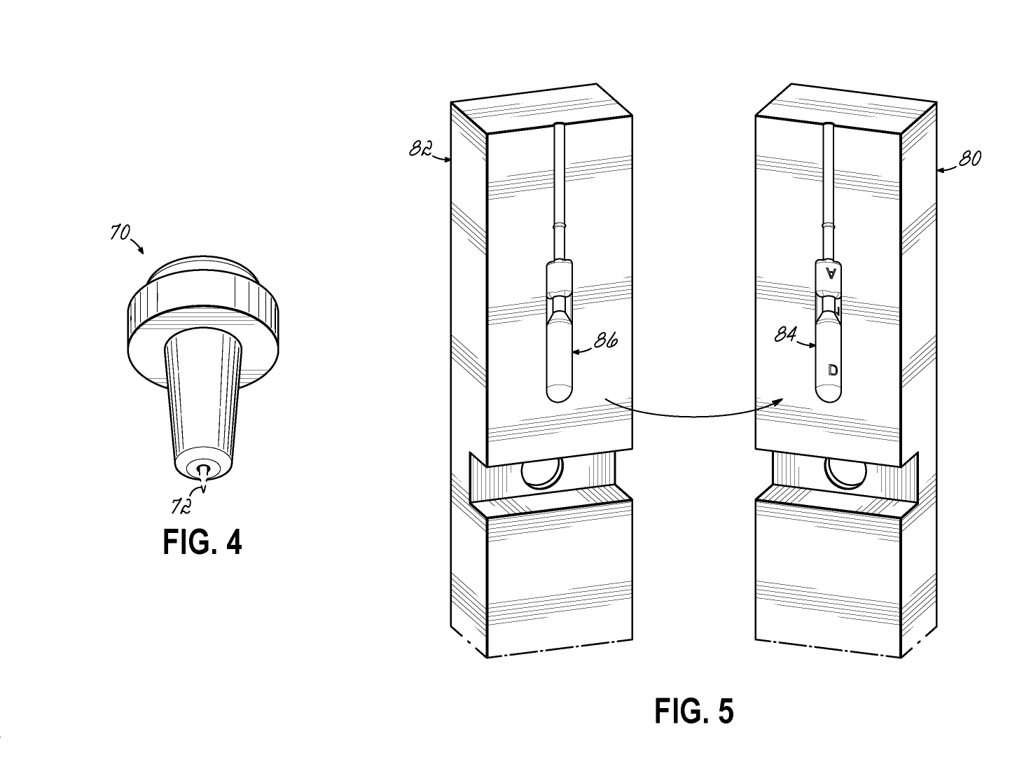

FIG. 4 shows a generically shaped piercing device 70 having a piercing element 72 for piercing (by “pricking”) the skin of a patient for exposing a supply of blood. The exposed blood may be drawn into the transfer pipette 10 and then transferred to a piece of filter paper 56 positioned in the sample holding container 58, in the manner generally described above. The blood sample may then be safely stored and transported for subsequent screening or analysis as described above. The transfer pipette 10, the filter paper 56, the sample holding container 58, the transport container and desiccant (not shown), the piercing device 70, and the sample bag (not shown), may all be packaged together as a kit for use in blood screening or other suitable applications, for example.

Alternatively, the transfer pipette 10 may be supplied in bulk to permit transfer of liquid from one container or test tube to another container or test tube, or from a container, a test tube, or a heel or finger prick to a testing device, for example.

Referring to FIG. 5, the transfer pipette 10 may be formed through an extrusion blow molding process using steps as generally known in the art. More specifically, a cylindrical parison (not shown) of molten polymeric material may be formed using an extruder device. In one embodiment, the parison may be formed with a diameter of approximately 3/32 inches to approximately 1 inch, such as approximately ⅜ inches, for example. The parison is then positioned between front and rear mold halves 80, 82 having corresponding front and rear mold cavity halves 84, 86 that include the negatives of the features to be formed for the resultant transfer pipette 10. The mold halves 80, 82 are then clamped together with the parison in between, and with a blow pin (not shown) inserted through an open end of the parison. Air is then injected through the blow pin into the parison, causing the parison to expand within the mold cavity 84, 86, thereby producing a raw form of the transfer pipette 10. The raw form of the transfer pipette 10 is then removed from the mold halves 80, 82 and may be subjected to final trimming and finishing procedures.

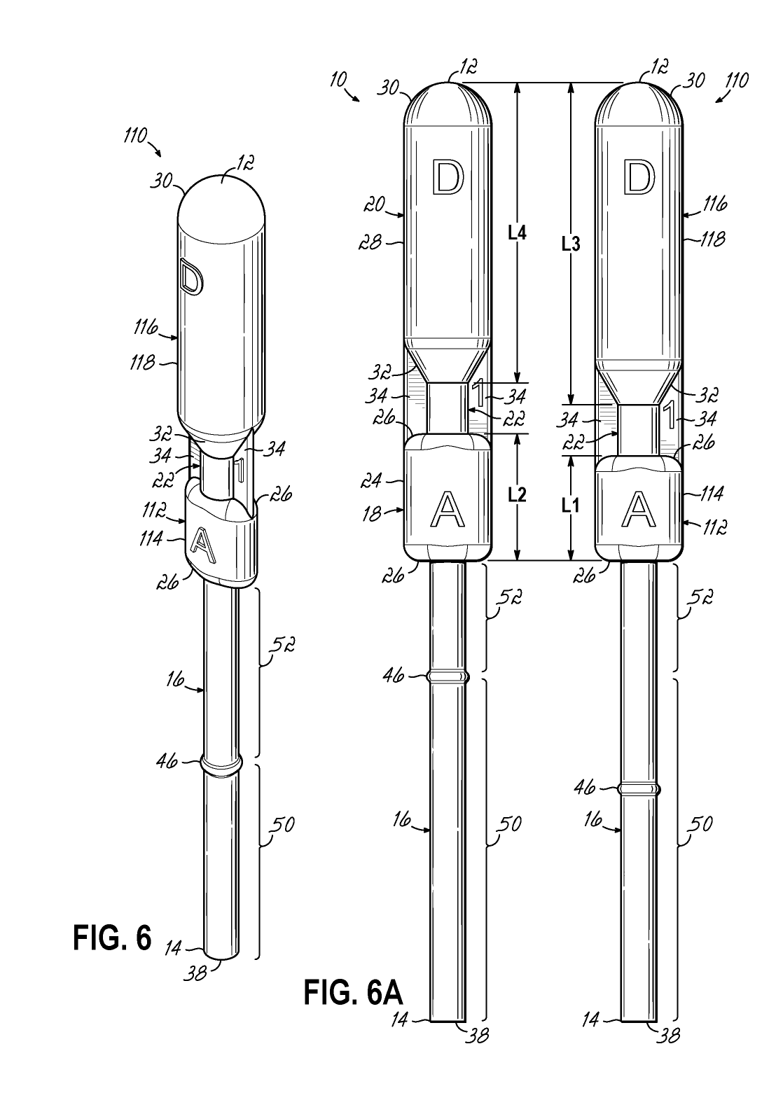

Referring to FIGS. 6-8B, transfer pipettes 110 and 210 in accordance with additional exemplary embodiments of the invention are shown, for which like reference numerals refer to like features of transfer pipette 10. The pipettes 110, 210 are generally similar in construction and function to pipette 10, except as otherwise described below.

Referring to FIGS. 6 and 6A, transfer pipette 110 includes a first squeeze bulb 112 having a shortened tubular portion 114 and defining a first fluid chamber (not shown). The shortened tubular portion 114 is formed with a cross-sectional profile of similar non-circular shape and size to that of the tubular portion 24 of first squeeze bulb 18 of transfer pipette 10. As shown, the first squeeze bulb 112 is formed with an axial length L1 that is shorter than a corresponding axial length L2 of the first squeeze bulb 18 of pipette 10. Accordingly, the internal volume of the first fluid chamber of pipette 110 is smaller than that of the first fluid chamber 42 of pipette 10, for drawing a smaller nominal intended volume of material into draw tube 16. In an exemplary embodiment, the first squeeze bulb 18 and first fluid chamber 42 of pipette 10 may be sized to aspirate approximately 75 μL of material. By comparison, the first squeeze bulb 112 and first fluid chamber of pipette 110 may be sized to aspirate approximately 50 μL of material, for example.

The decreased internal volume of the first fluid chamber of pipette 110 causes a smaller volume of air to be expelled from the first squeeze bulb 112 when the bulb 112 is fully compressed, as compared to pipette 10. Consequently, when the first squeeze bulb 112 is released and allowed to return to its relaxed state, a smaller volume of material is drawn into draw tube 16. Accordingly, the proximal-most volume indicating element or graduation mark 46 provided on draw tube 16 is positioned closer to the distal end 14 on pipette 110 than on pipette 10, indicating a material holding portion 50 of decreased volume. It will be appreciated that the first squeeze bulb, or aspiration bulb, of the pipettes disclosed herein may be formed with any suitable length and cross-sectional shape and size for aspirating any suitable nominal intended volume of material.

As shown in FIG. 6A, a second squeeze bulb 116 of transfer pipette 110 may be formed with a lengthened tubular portion 118 that contributes to an axial length L3 of the second squeeze bulb 116 that is longer than a corresponding axial length L4 of the second squeeze bulb 20 of transfer pipette 10. Further, a combined length of the first squeeze bulb 18, the second squeeze bulb 20, and the connecting tube 22 of pipette 110 may be substantially the same as a corresponding combined length of these elements of pipette 10. Accordingly, and advantageously, the overall length of pipette 110 may be kept substantially the same as that of pipette 10, such that the same size parison may be used for forming both pipettes 10, 110.

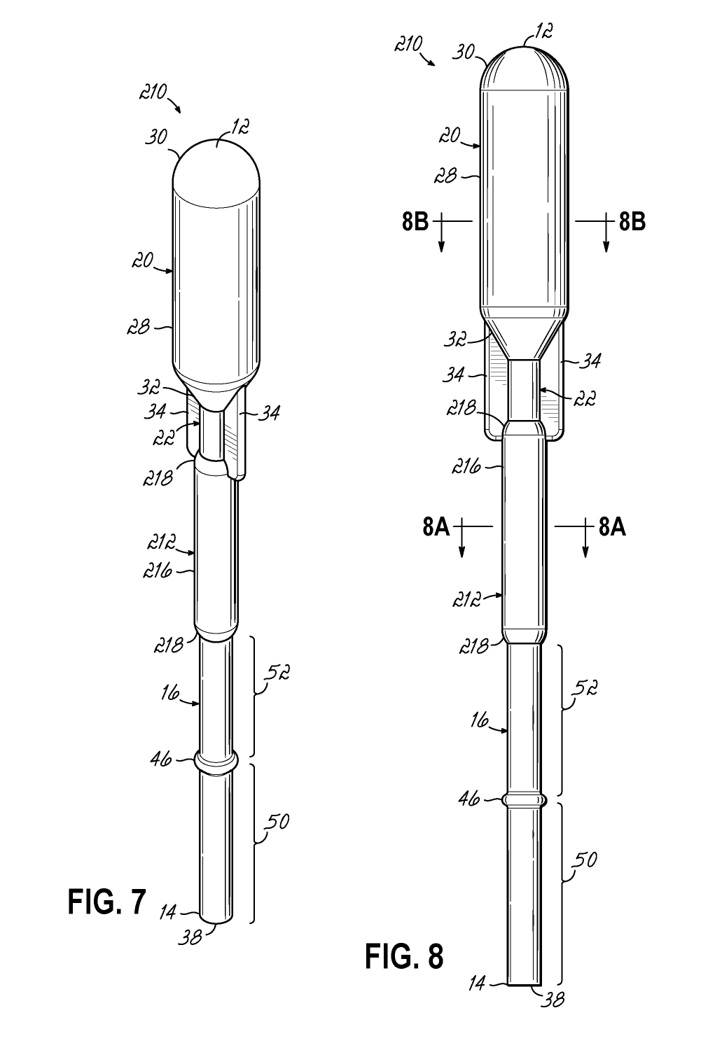

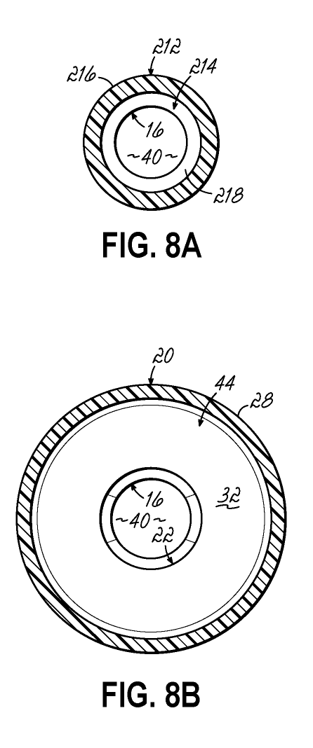

Referring to FIGS. 7-8B, transfer pipette 210 includes a first squeeze bulb 212 defining a first fluid chamber 214 (see FIG. 8A) and having a tubular portion 216 formed with a substantially circular cross-sectional shape, as shown best in FIG. 8A. The tubular portion 216 has proximal and distal rounded portions 218. As shown in the illustrated embodiment, the first squeeze bulb 212, and in particular the tubular portion 216, is formed with an outer diameter that is smaller than that of the second squeeze bulb 20 and larger than that of the draw tube 16. In an exemplary embodiment, the first squeeze bulb 212 may be formed with an outer diameter and length suitable for aspirating a nominal intended volume of material of approximately 30 μL, for example. In alternative embodiments, the first squeeze bulb 212 may be formed with any suitable outer diameter and length for aspirating any desired nominal intended volume of material.

As will be appreciated by persons skilled in the art of blow molding, for a parison having a given pre-blown wall thickness, the wall thickness of a bulb blown from the parison is inversely proportional to an outer diameter of the blown bulb. That is, a blown bulb having a smaller outer diameter will have a greater wall thickness than a blown bulb having a larger outer diameter. In the context of exemplary pipette 210, as shown in FIGS. 8A and 8B, the smaller outer diameter of first squeeze bulb 212 relative to that of second squeeze bulb 20 yields a greater wall thickness for the first squeeze bulb 212 than for the second squeeze bulb 20. That is, a minimum wall thickness of the first squeeze bulb 212 is greater than a minimum wall thickness of the second squeeze bulb 20. Moreover, the outer diameter of first squeeze bulb 212 of pipette 210 may be less than a nominal outer diameter of first squeeze bulb 18 of pipette 10, such that bulb 212 is formed with a greater wall thickness than bulb 18.

As described above, the non-circular shaped cross-section of first squeeze bulb 18 of transfer pipette 10 aids in reducing the rate at which the bulb sidewall 48 rebounds from a compressed state to its relaxed state, thereby contributing to a desirable slower material draw rate than that achieved by known transfer pipettes. Advantageously, a similar slower rebound rate of the first squeeze bulb 212 of pipette 210 is achieved as a result of the increased wall thickness of bulb 212 relative to the wall thickness of bulb 18 of pipette 10. To that end, it will be understood that squeeze bulbs of greater wall thicknesses generally rebound at slower rates than similarly shaped squeeze bulbs of lesser wall thicknesses. Accordingly, it will be appreciated that an aspiration bulb of a transfer pipette in accordance with an embodiment of the invention may be formed with a non-circular shaped cross-section, an increased wall thickness (e.g., by virtue of a decreased outer diameter), or a combination of both in order to achieve a generally slower bulb rebound rate that contributes to a desirable slower material draw rate.

Moreover, in embodiments in which both the aspiration bulb and the dispense bulb are formed with circular cross-sectional shapes and are arranged linearly, as exemplified by transfer pipette 210, the resulting pipette is fully symmetrical circumferentially about a single longitudinal axis. Advantageously, such a configuration may increase ease of manufacture, and thus decrease costs, associated with corresponding blow molds (see, e.g., molds 80, 82 of FIG. 5).

Referring to FIG. 9, a table 300 displaying characteristics of transfer pipettes according to various exemplary embodiments of the invention is shown. The table 300 includes ten columns, as described below in a direction from left to right. First column 302 of table 300 enumerates exemplary Embodiments 1-11 of transfer pipettes. For each of the Embodiments 1-11, the remaining columns of table 300 provide corresponding information relating to a respective characteristic.

Second column 304 of table 300 indicates an aspiration volume, measured in μL, for each Embodiment 1-11. This measurement corresponds to an internal volume of the material holding portion of the draw tube of each pipette (see, e.g., material holding portion 50 of draw tube 16 of pipette 10). As shown, these volumes may range from approximately 30 μL to approximately 225 μL, for example.

Third column 306 of table 300 provides a brief description for each Embodiment 1-11 with respect to whether the Embodiment 1-11 includes one, multiple, or no graduation marks (see, e.g., volume indication element or graduation mark 46), and a general cross-sectional shape of the aspiration bulb (e.g., first squeeze bulb 18). Embodiment 7, having an aspiration bulb with a circular cross-sectional shape, may be an exemplary embodiment of the transfer pipette 210 shown in FIGS. 7-8B, for example.

Fourth column 308 of table 300 indicates an outer diameter, measured in inches, of a draw tube at the distal end of each Embodiment 1-11 (see, e.g., draw tube 16 at distal end 14 of pipette 10).

Fifth column 310 of table 300 indicates a distance, measured in inches, between the distal end of the draw tube and any volume indicating elements or graduation marks provided on the draw tube (see, e.g., distance between distal end 14 of draw tube 16 and volume indicating element 46). For example, Embodiment 6 includes two graduation marks positioned at 0.68 inches and 1.01 inches, respectively, from the distal end of the draw tube.

Sixth column 312 of table 300 indicates a length, measured in inches, of a draw tube of each Embodiment 1-11. This measurement corresponds to the distance between the distal end of the draw tube and the distal end of the aspiration bulb (see, e.g., distance between distal end 14 of draw tube 16 and the distal end of first squeeze bulb 18 of pipette 10). As shown, pipettes with larger aspiration volumes may have longer draw tubes.

Seventh column 314 of table 300 indicates a major axis dimension, a minor axis dimension, and a length, all measured in inches, of the aspiration bulb for those Embodiments in which the aspiration bulb is formed with an oval cross-sectional shape (see, e.g., first squeeze bulb 18 in FIG. 2A). As shown, the dimensions of the oval cross-sectional shape of the aspiration valve may be increased, or decreased, in order to increase, or decrease, the pipette aspiration volume. Embodiment 5, having an aspiration bulb of shortened length, may be an exemplary embodiment of the transfer pipette 110 shown in FIGS. 6 and 6A, for example.

Eighth column 316 of table 300 indicates an outer diameter, measured in inches, of the aspiration bulb for those Embodiments in which the aspiration bulb is formed with a circular cross-section; in particular, Embodiment 7.

Ninth column 318 of table 300 indicates an outer diameter, measured in inches, of the circular cross-section of the dispense bulb of each Embodiment 1-11 (see, e.g., second squeeze bulb 20 of pipette 10).

Tenth column 320 of table 300 indicates an overall length, measured in inches, of each Embodiment 1-11 (see, e.g., distance between proximal end 12 and distal end 14 of pipette 10).

While the present invention has been illustrated by the description of specific embodiments thereof, and while the embodiments have been described in considerable detail, it is not intended to restrict or in any way limit the scope of the appended claims to such detail. The various features discussed herein may be used alone or in any combination. Additional advantages and modifications will readily appear to those skilled in the art. The invention in its broader aspects is therefore not limited to the specific details, representative apparatus and methods and illustrative examples shown and described. Accordingly, departures may be made from such details without departing from the scope of the general inventive concept.

What is claimed is:

1. A transfer pipette, comprising:
a draw tube having a proximal end, a distal end, and a lumen;
a first squeeze bulb defining a first fluid chamber in fluid communication with the lumen at the proximal end; and
a second squeeze bulb defining a second fluid chamber in fluid communication with the first fluid chamber,
wherein when the first squeeze bulb is squeezed into a compressed state a volume of air is evacuated from the first fluid chamber, and when the first squeeze bulb is released from the compressed state an intended nominal volume of material is drawn into the draw tube through the distal end, and
wherein when the second squeeze bulb is compressed at least a portion of the intended nominal volume of material is dispensed from the draw tube through the distal end.

2. The transfer pipette of claim 1, wherein the first squeeze bulb is positioned between the draw tube and the second squeeze bulb, and wherein when the first squeeze bulb is released from the compressed state air is drawn from the second fluid chamber into the first fluid chamber while the intended nominal volume of material is drawn into the draw tube.

3. The transfer pipette of claim 1, wherein the draw tube includes a material holding portion for holding the intended nominal volume of material drawn into the draw tube, and wherein the first fluid chamber is formed with a volume that is greater than an internal volume of the material holding portion.

4. The transfer pipette of claim 3, wherein the first fluid chamber is formed with a volume that is at least 5% larger than the internal volume of the material holding portion.

5. The transfer pipette of claim 4, wherein the first fluid chamber is formed with a volume that is at least 10% larger than the internal volume of the material holding portion.

6. The transfer pipette of claim 1, wherein the second fluid chamber is formed with a volume that is greater than a volume of the first fluid chamber.

7. The transfer pipette of claim 1, wherein the draw tube includes a material holding portion for holding the intended nominal volume of material drawn into the draw tube, and wherein the second fluid chamber is formed with a volume that is at least 1.5 times an internal volume of the material holding portion.

8. The transfer pipette of claim 1, wherein the first squeeze bulb is formed with a non-circular cross-section.

9. The transfer pipette of claim 8, wherein the first squeeze bulb is formed with one of a flattened shaped cross-section, an oval shaped cross-section, or an elliptical shaped cross-section.

10. The transfer pipette of claim 1, wherein the first squeeze bulb is formed with a circular cross-section.

11. The transfer pipette of claim 1, wherein the first squeeze bulb is sized such that the intended nominal volume of material drawn into the draw tube is less than or equal to approximately 30 μL.

12. The transfer pipette of claim 1, wherein the first squeeze bulb is formed with a maximum outer diameter that is smaller than a maximum outer diameter of the second squeeze bulb, and the first squeeze bulb is formed with a minimum wall thickness that is greater than a minimum wall thickness of the second squeeze bulb.

13. The transfer pipette of claim 1, further comprising:
a connecting tube extending between the first squeeze bulb and the second squeeze bulb, the connecting tube establishing the fluid communication between the first fluid chamber and the second fluid chamber.

14. The transfer pipette of claim 1, further comprising:
at least one volume indicating element formed on the draw tube and configured to provide a visual indication of a volume of the material contained within the draw tube.

15. The transfer pipette of claim 1, further comprising:
a fin extending from a proximal end of the second squeeze bulb.

16. A kit, comprising:
the transfer pipette of claim 1; and
a fluid absorbent medium adapted to receive thereon at least a portion of the intended nominal volume of material dispensed from the draw tube.

17. The kit of claim 16, further comprising:
a sample holding container configured to receive the fluid absorbent medium.

18. The kit of claim 17, further comprising:
a desiccant; and
a closure configured to close an opening of the sample holding container.

19. The kit of claim 17, wherein the material includes blood, the kit further comprising:
a piercing device operable to pierce the skin of a patient for exposing a supply of blood from the patient.

20. A transfer pipette, comprising:
a body having an open end and a closed end;
first and second fluid passageways located between the open end and the closed end, the first fluid passageway terminating at the open end;
a first squeeze bulb located between the first and second fluid passageways and defining a first fluid chamber in fluid communication therewith; and
a second squeeze bulb located between the second fluid passageway and the closed end and defining a second fluid chamber in fluid communication with the first and second fluid passageways;
wherein when the first squeeze bulb is squeezed into a compressed state a volume of air is evacuated from the first fluid chamber, and when the first squeeze bulb is released from the compressed state a predetermined volume of material is drawn into the first fluid passageway through the open end of the body, and
wherein when the second squeeze bulb is compressed the predetermined volume of material is dispensed from the first fluid passageway through the open end.

21. A method of transferring material with a transfer pipette, the method comprising:
compressing a first squeeze bulb of the transfer pipette;
positioning an open end of the transfer pipette in fluid communication with a supply of material;
releasing the first squeeze bulb to allow an intended nominal volume of the material to be drawn into the transfer pipette through the open end; and
compressing a second squeeze bulb of the transfer pipette to dispense at least a portion of the intended nominal volume of the material from the transfer pipette through the open end.

22. The method of claim 21, wherein compressing the first squeeze bulb includes contacting a first side wall of the first squeeze bulb with an oppositely disposed second side wall of the first squeeze bulb.

23. The method of claim 21, wherein releasing the first squeeze bulb includes allowing a volume of air to be drawn from a second fluid chamber of the second squeeze bulb into a first fluid chamber of the first squeeze bulb.

24. The method of claim 21, wherein the material includes a liquid, and releasing the first squeeze bulb includes allowing the intended nominal volume of liquid to be drawn into the transfer pipette at a flow rate sufficient to avoid formation of bubbles within the liquid in the transfer pipette.

25. The method of claim 21, further comprising:
after the intended nominal volume of material is drawn into the transfer pipette, positioning the open end within a container, and
wherein compressing the second squeeze bulb includes dispensing at least a portion of the intended nominal volume of the material onto a medium positioned within the container.
